(19) United States
(12) Patent Application Publication
(10) Pub. No.: US 2008/0110304 A1
(43) Pub. Date: May 15, 2008

(54) Probe clamp

(75) Inventors: Yu-Min Cheng, Taipei County (TW); Wen-Ying Cheng, Taipei County (TW); Min-Hsiang Sung, Kaohsiung County (TW)

Correspondence Address: BIRCH STEWART KOLASCH & BIRCH, PO BOX 747, FALLS CHURCH, VA, 22040-0747, US

(73) Assignee: C.C.P. CONTACT PROBES CO., LTD.

(21) Appl. No.: 11/599,368

(22) Filed: Nov. 15, 2006

(51) Int. Cl. B25B 7/12

(52) U.S. Cl. 81/345; 81/409.5

(57) ABSTRACT

The present invention discloses a probe clamp used for removing a damaged probe. The probe clamp includes a container, a seizing head and a push rod, and the seizing head is sheathed onto a desired removing probe. If a force is applied to drive the push rod to withdraw the seizing head, then the damaged probe can be clamped tightly for the removal. The probe clamp of the invention not only can seize the damaged probe quickly and precisely, but also can clamp and remove the probe effectively, so that the probe will not slide or touch other probes that may result in damaging more probes. Therefore, the invention improves the working efficiency and reduces the consumption of probes effectively.

### FIELD OF THE INVENTION

The present invention relates to a clamp, and more particularly to a probe clamp used for removing a damaged probe.

### BACKGROUND OF THE INVENTION

The scope of applicability of a probe is very broad, and present probes are mainly used for testing different finished goods and components. In general, a probe is installed to a testing mold and in contact with a testing component, and the probe sends a testing result back to a computer through a conducing wire to confirm whether or not the testing component is defective, and such electric test usually requires high-precision testing instruments, and the quality of the probe also has a significant effect on the accuracy of the test.

A traditional probe unit is mainly a needle type probe unit, and several slender probes are assembled manually and then fixed by a glue to form a needle-type probe unit. Although such probe unit has the advantages on its short manufacturing time, small quantity, large variety and high flexibility for the manufacture, yet it still has some shortcomings on the basic design, such as using a three-dimensional space for disposing the probe to shorten the distance of the probe effectively, but such arrangement will cause different forces that are exerted on the probes at different layers, and will result in damages to the probes, and also has a limitation on the number of testing probes. Therefore, traditional probes are not applicable for short-distance testing, and it is also difficult for users to change the probes of this sort.

Till now, various probes are developed, and some of them are disclosed in R.O.C. Patent Nos. 392073, 548409 and 516633, and these patents have made improvements to probe units and probes. If a probe is determined to be damaged in a test, the whole probe will be replaced. The probe in a container is generally removed by a simple tool (such as a pair of tweezers). Since there are so many probes to be tested, users always find it difficult to apply a force during their using such tool (or tweezers), if a probe is damaged, and the probe may slide easily. Such tweezers cannot remove the damaged probe accurately, and may even damage other good probes that will result in an increase of costs.

### SUMMARY OF THE INVENTION

In view of the foregoing shortcomings of the prior art that a force cannot be applied to a traditional probe clamp conveniently, and the probe slides easily and cannot be removed precisely and the cost may be increased, the present invention provides a probe clamp to overcome the shortcomings of the prior art.

Therefore, it is a primary objective of the present invention to provide a probe clamp applicable for removing a damaged probe, and the probe clamp comprises: a container, a through hole disposed on the container, and a seizing head. The seizing head comprises a plurality of seizing plates passing through the through hole, a head end and a neck portion connected to the seizing plates and the head end. The neck portion comprises a slant in contact with the through hole, and the seizing head can be moved back and forth between a first position and a second position and is normally situated at the first position, and the plurality of seizing plates are separated from each other to form an open state. At the second position, the slant of the neck portion is forced by the through hole to drive the plurality of seizing plates together into a closed state. The probe clamp further comprises a push rod installed into the container and moved with respect to the container. The push rod includes a force applying portion and a pushing portion, and the pushing portion can push the seizing head to the second position or release the seizing head to return to the first position.

### BRIEF DESCRIPTION OF THE DRAWINGS

FIG. 1 is a perspective view of the present invention;

FIG. 2 is an exploded view of the present invention;

FIGS. 3A and 3B show the motions of the present invention;

FIG. 4 is a schematic view of an application of the present invention; and

FIG. 5 is a cross-sectional view of another preferred embodiment of the present invention.

### DETAILED DESCRIPTION OF THE PREFERRED EMBODIMENTS

The present invention will now be described in more detail hereinafter with reference to the accompanying drawings as follows:

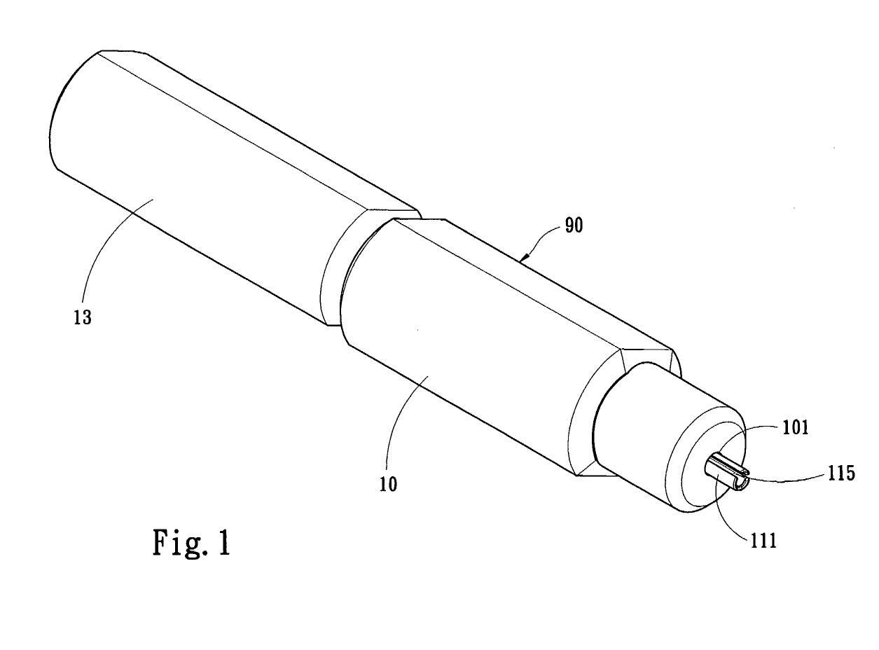

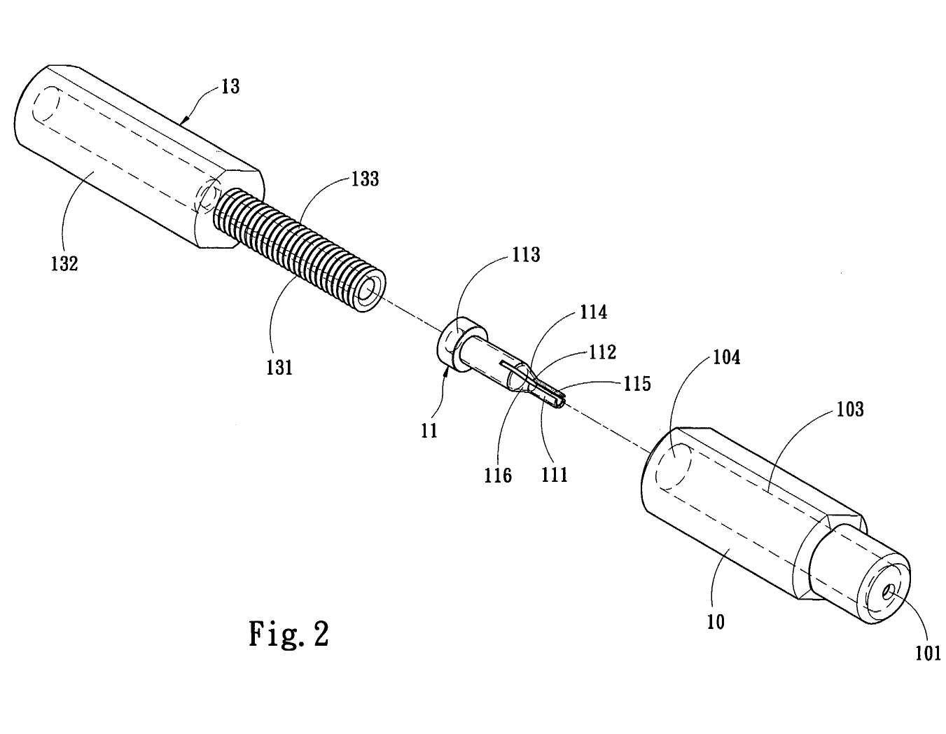

Referring to FIGS. 1 and 2 for a perspective view and an exploded view of the present invention respectively, a probe clamp comprises: a container 10 (which can be a tubular element), and an end of the container 10 has a through hole 101, and the container 10 contains a resisting wall 102 coupled to an internal wall of the through hole 101, and another end of the container 10 has an opening 104, and the internal wall of the container has a female thread 103; a push rod 13, having a force applying portion 132 and a pushing portion 131, and the exterior of the pushing portion 131 has a male thread 133; a seizing head 11 (which can be a tubular element) disposed in the container 10, and the seizing head 11 includes a plurality of seizing plates 111, a head end 113 and a neck portion 112 of the head end 113 connected to the seizing plate 111; a crevice 115 disposed on the seizing head 11, and two adjacent crevices 115 form a plurality of seizing plates 111, and the neck portion 112 is a conical body 116, with an end of a larger external diameter connected to the head end 113, and an end of a smaller external diameter connected to a plurality of seizing plates 111, and an end of smaller external diameter of the conical body 116 is passed through the through hole 101; a slant 114 disposed at the neck portion 112 of the seizing head 11 and in contact with the through hole 101, and the seizing head 11 can be moved back and forth between a first position and a second position and is normally situated at the first position, and the plurality of seizing plates 111 are separated from each other and spread into an open state, and at the second position, the slant 114 of the neck portion 112 is forced by the through hole 101 to drive the plurality of seizing plates 111 together into a closed state; and a push rod 13 installed into the container 10 and moved with respect to the container 10, and the push rod 13 has the force applying portion 132 and the pushing portion 131, and the pushing portion 131 can push the seizing head 11 to the second position or release the seizing head 11 to return to the first position.

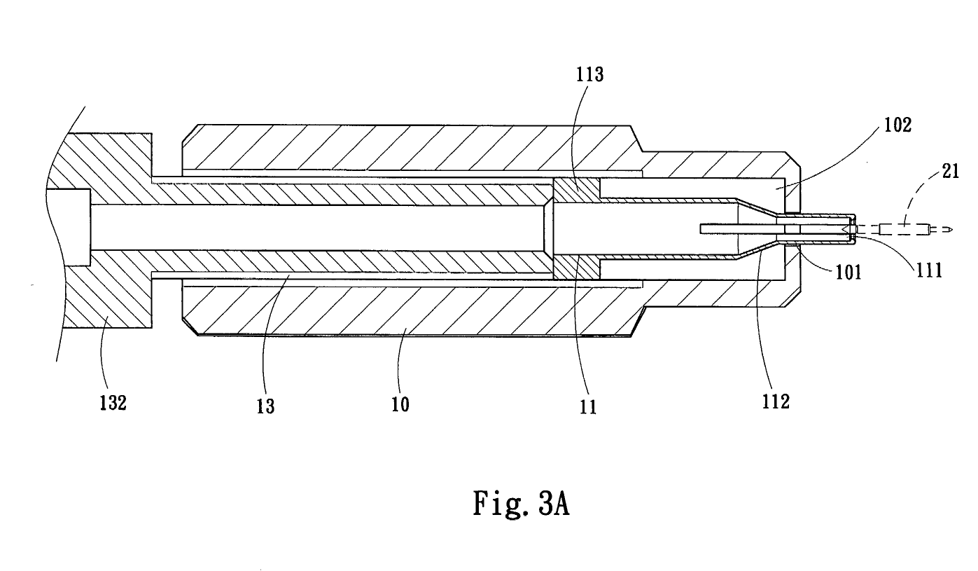

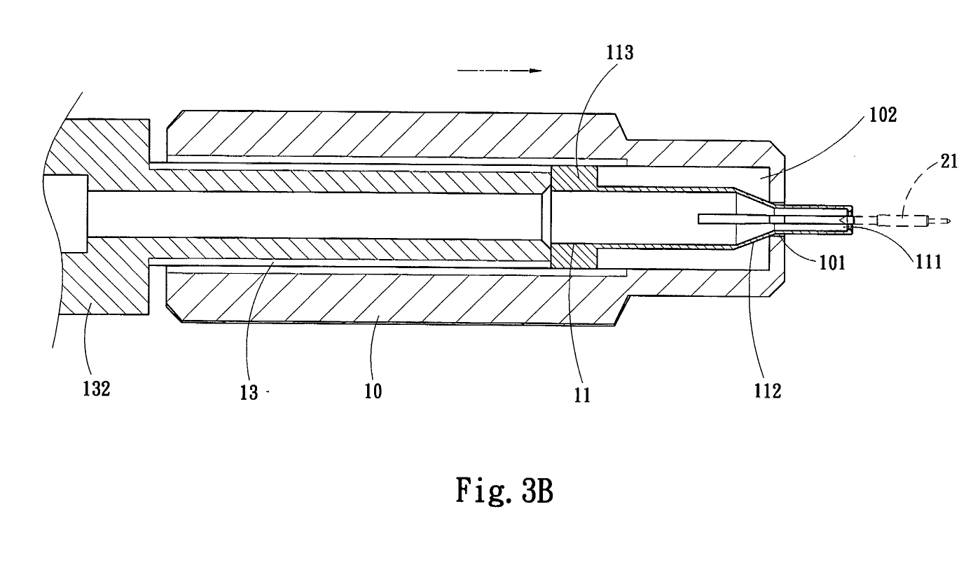

Referring to FIG. 3A, an end of the container 10 (which can be a tubular element) has a through hole 101, and the container 10 includes the resisting wall 102, and the opening 104 disposed axially at an end of the container 10. The force applying portion 132 and the pushing portion 131 press the head end 113 of the seizing head 11, and another end of the seizing head 11 has the slant 114 of the neck portion 112 in contact with the resisting wall 102 of the container 10. The seizing head 11 has the seizing plates 111 that are pass through the through hole 101 in the container 10 to the first position, and the interior of the container 10 has a female thread 103 engaged with a male thread 133 on the external surface of the pushing portion 131 of the push rod 13.

Referring to FIG. 3B, the seizing plates 111 of the seizing head 11 can pass through the through hole 101 of the container 10 to the first position. If the force applying portion 132 starts operating, the pushing portion 131 of the force applying portion 132 will press the head end 113 of the seizing head 11, and a force will be exerted at the front end of the slant 114 of the neck portion 112 of the seizing head 11 to touch the front end with the resisting wall 102 of the through hole 101, so that the slant 114 of the neck portion 112 is withdrawn first, and a portion of the slant 114 of the neck portion 112 is passed through and out from the through hole 101 of the container 10, and the seizing plate 111 is extended to a second position to clamp the probe 21 for the removal operation.

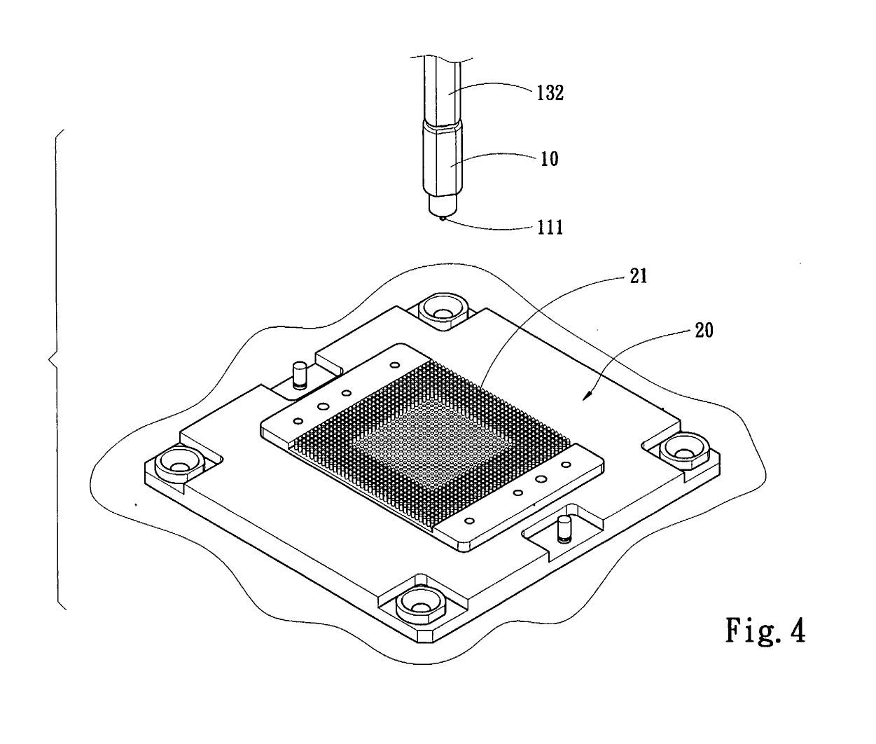

Referring to FIG. 4, a probe clamp 90 of the present invention is used, if the probe unit 20 is used for testing and the probe 21 is damaged. When the push rod 13 is pushed onto the force applying portion 132, the pushing portion 131 will push the seizing head 11 to the second position to clamp the probe 21, so that the invention can avoid the traditional error of removing a probe 21 and reduce a possible damage to other good probes 21 due to collisions, so as to enhance the precision of the operation.

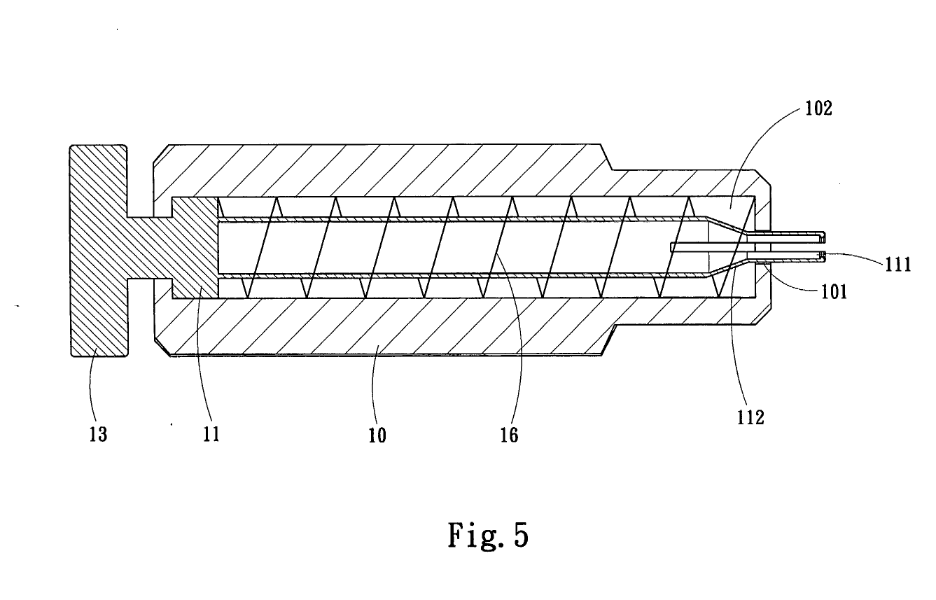

Referring to FIG. 5 for another preferred embodiment of the present invention, a probe clamp of this embodiment comprises: a push rod 13 that presses a seizing head 11, and the external periphery of the seizing head 11 is wound by a resilient element 16 (which can be a compression spring); a container 10 for containing the resilient element 16, and an end of the resilient element 16 presses against a force applying portion 132 of a push rod 13, and another end of the resilient element 16 presses against a resisting wall 102 of the container 10, such that the resilience of the resilient element 16 can push the push rod 13 to position the seizing head 11 at a first position.

While the invention has been described by means of specific embodiments, numerous modifications and variations could be made thereto by those skilled in the art without departing from the scope and spirit of the invention set forth in the claims.

What is claimed is:

1. A probe clamp, applicable for removing a damaged probe, comprising:
a container, having a through hole;
a seizing head, having a plurality of seizing plates passed through said seizing head, a head end and a neck portion connected to said seizing plates and said head end, and said neck portion comprising a slant in contact with said through hole, and said seizing head can be moved back and forth between a first position and a second position, such that said seizing head is normally situated at said first position, and said plurality of seizing plates are separated from each other and spread into an open state, and said slant of said neck portion is forced by said through hole to drive said plurality of seizing plates into a closed state when said seizing head is situated at said second position; and
a push rod, installed into said container, and moved with respect to said container, and said push rod has a force applying portion and a pushing portion, and said pushing portion is capable of pushing said seizing head to said second position or releasing said seizing head to return said seizing head to said first position.

2. The probe clamp of claim 1, wherein said container is a tubular element having an opening disposed axially at an end of said container, and said through hole is disposed at another end of said container.

3. The probe clamp of claim 2, wherein said seizing head is a tubular element, and a crevice is formed between said plurality of seizing plates, and said neck portion is a conical body with an end of a larger external diameter connected to said head end and an end of a smaller external diameter connected to said plurality of seizing plates, and an end of smaller diameter of said conical body is passed through said through hole.

4. The probe clamp of claim 2, wherein said push rod has a male thread disposed at an external surface of said pushing portion, and a corresponding female thread disposed on an internal wall of said container.

5. The probe clamp of claim 1, wherein said pushing portion is a resilient element.

6. The probe clamp of claim 5, wherein said resilient element is a compression spring.

7. The probe clamp of claim 1, further comprising a resilient element installed at said container, and an end of said resilient element presses said force applying portion of said push rod and another end of said resilient element presses an internal sidewall of said container, such that the resilience of said resilient element pushes said push rod to position said seizing head at said first position.
